(19) United States
(12) Patent Application Publication
(10) Pub. No.: US 2020/0245040 A1
(43) Pub. Date: Jul. 30, 2020

(54) SECURING AND SEGMENTAL SHARING OF MULTIMEDIA FILES

(71) Applicant: International Business Machines Corporation, Armonk, NY (US)

(72) Inventor: HAMID MAJDABADI, Ottawa (CA)

(21) Appl. No.: 16/257,306

(22) Filed: Jan. 25, 2019

(51) Int. Cl. H04N 21/845; H04N 21/472; H04N 21/835

(52) U.S. Cl. CPC H04N 21/8456; H04N 21/835; H04N 21/47202; H04N 21/8455

(57) ABSTRACT

A method and related system for securely segmenting and distributing media are provided. The method presents a multimedia file within a user interface and identifies selection of a distribution element within the user interface. The method generates one or more segmentation elements within the user interface and identifies interaction with at least one segmentation element of the one or more segmentation elements. The method generates one or more file segments, from the multimedia file, based on interaction with the at least one segmentation element. The method then generates a message with the one or more file segments.

### FIELD OF THE DISCLOSURE

The present disclosure relates generally to a method for secure distribution of media, and more specifically, but not exclusively, to a computer-implemented method for securely segmenting and distributing media to specified recipients. The present disclosure relates further to a related system for secure distribution of media, and a computer program product.

### BACKGROUND

Computer systems and communications networks enable distribution or sharing of data and media files. Typically, current computing systems perform sharing functions using standard messaging protocols or social media. These protocols enable users to transmit files or links to other users of the messaging protocols or social media systems. Sharing in this manner transfers a file or a network location from one user or business to another. Further, sharing in this manner transfers or provides access to the full file stored on the network location or transmitted within the message. If portions of the file are irrelevant to a recipient, a sender may bookmark or otherwise designate one or more locations in the file. Although bookmarking may indicate a starting and ending location (or bounded portion) of one or more relevant portions to which the recipient should direct attention, bookmarking may not provide an indication as to whether the associated location is a start or end location. Further, if the recipient chooses to view or otherwise consume other portions of the file, the recipient may have no ability to access the portions not considered relevant.

### SUMMARY

According to an embodiment described herein, a computer-implemented method for secure distribution of media is provided. The media may be securely distributed by causing presentation of a multimedia file within a user interface. The method may further comprise identifying selection of a distribution element within the user interface. One or more segmentation elements are generated within the user interface based on the selection of the distribution element. Interaction with at least one segmentation element is identified. The at least one segmentation element may be one or more of the segmentation elements generated within the user interface. The method further comprises generating one or more file segments from the multimedia file. Generation of the file segments is based on interaction with the at least one segmentation element. The method then generates a message with the one or more file segments. The message configured for distribution across a computer network infrastructure.

In some embodiments, the interaction with the at least one segmentation element is a plurality of interactions. In these instances, the method may further comprise determining a first portion of the multimedia file. The first portion may correspond to a predetermined position within the multimedia file. A second position may also be determined within the multimedia file. The second position may correspond to the interaction with the at least one segmentation element.

According to some embodiments, the interaction with the at least one segmentation element is a plurality of interactions. In these instances, the method may further comprise determining a first position within the multimedia file. The first position may correspond to a first interaction with a segmentation element of the one or more segmentation elements. One or more subsequent positions may also be determined within the multimedia file. The subsequent position or subsequent positions may correspond to a subsequent interaction with a segmentation element of the one or more segmentation elements.

According to some embodiments, the method may comprise identifying a first portion of a multimedia file occurring between a first position and a second position within the multimedia file. The method may identify a second portion of the multimedia file occurring between subsequent positions within the multimedia file. The method then segments the first portion and the second portion of the multimedia file.

According to some embodiments, the method further comprises causing presentation of a set of recipients. The set of recipients may be presented based on selection of a distribution element. The method may identify selection of one or more recipients within a user interface. In response to identifying an interaction with at least one segmentation element and generating one or more file segments, the method may assign at least one of the selected recipients to each file segment.

According to some embodiments, the method may comprise generating a plurality of file segments. In these instances, the method may identify a distribution type based on selection of a distribution element. The method may combine the plurality of file segments into a distribution file. The distribution file may exclude at least a portion of a multimedia file from which the file segments are generated. The method may generate a message with the distribution file and one or more recipients assigned to the distribution file.

Some embodiments of the inventive concepts described herein may take the form of a system or a computer program product. For example, a computer program product may store program instructions that, when executed by one or more processors of a computing system, cause the computing system to perform operations described above with respect to the computer implemented method. By way of further example, the system may comprise components, such as processors and computer readable storage media. The computer readable storage media may interact with other components of the system to cause the system to execute program instructions comprising operations of the computer implemented method, described herein. For the purpose of this description, a computer-usable or computer-readable storage medium may be any apparatus that may contain means for storing, communicating, propagating or transporting the program for use, by, or in connection, with the instruction execution system, apparatus, or device.

### BRIEF DESCRIPTION OF THE DRAWINGS

FIG. 1 depicts a block diagram of a computer-implemented method for segmenting and distributing media, according to at least one embodiment.

FIG. 2 depicts a flowchart of a computer-implemented method for segmenting and distributing media, according to at least one embodiment.

FIG. 3 shows a user interface of an embodiment of a display screen generated as part of the computer-implemented method for segmenting and distributing media, according to at least one embodiment.

FIG. 4 shows a user interface of an embodiment of a display screen generated as part of the computer-implemented method for segmenting and distributing media, according to at least one embodiment

FIG. 5 depicts a flowchart of a computer-implemented method for segmenting and distributing media, according to at least one embodiment.

FIG. 6 depicts a flowchart of a computer-implemented method for segmenting and distributing media, according to at least one embodiment.

FIG. 7 depicts a block diagram of a computing system for segmenting and distributing media, according to at least one embodiment.

### DETAILED DESCRIPTION

Media and multimedia files are widely shared between users via multiple communications methods. For example, multimedia and content sharing frequently occurs via text message and email. With the introduction of social media platforms, the proliferation of content sharing continues between users and organizations alike. Most files are shared in forms of multimedia files containing an entire project, song, movie, presentation, animation, or other suitable data. Similarly, users often share links to such multimedia files stored within a network architecture. These files often include extra, irrelevant, or sensitive information. Users, sharing a link or an attached file, may not desire that the recipient view all of the included data. Rather, a sending user may desire that a recipient only view a specific portion or portions of a multimedia file. In addition to sharing only relevant information, users may have other information that they do not wish to share or prefer to keep secure.

Currently, file recipients may either search a received multimedia file for relevant portions or information. For example, upon receiving a file, a recipient may skim or otherwise search for relevant segments of a multimedia file. Senders may alleviate some of the recipients' searching by recording, bookmarking, or otherwise designating times, page numbers, or other indicators to which the recipient should direct attention.

Some senders may employ specially designed programs to edit and save modified versions of a multimedia file they intend to share. These senders may use manual procedures to identify, format, and separate out desired portions of the multimedia file prior to sending one or more of them to a recipient. This approach consumes time and computing resources, and employs varying skills of the sender. Further, for some multimedia files or data sources, manual editing may not be available. When manual modification of a multimedia file is unavailable, many senders resort to bookmarking or otherwise stating starting and ending markers (e.g., time codes or page numbers) of relevant information and transmitting the bookmarks or other markers to the recipient. Similar to manual modification, bookmarking operations may not be available to all senders for all files. Further, whether bookmarking or manually copying down markers, these manual operations come at a time, experience, and opportunity cost. Finally, these manual procedures maintain the entire multimedia file transmitted to the recipient. The recipient may choose to focus on the relevant information, or to peruse additional portions of the received multimedia file. As such, these manual procedures do not segment or securely transmit desired or relevant portions of a multimedia file.

Embodiments of the present disclosure enable secure segmentation and distribution of portions of multimedia files. According to the present disclosure, some embodiments enable automated selection and segmentation of a multimedia file. Further, the present disclosure enables sharing diverse files and file types across diverse devices and platforms. For example, through a user interface, common to a plurality of devices, selection of a distribution or sharing icon may trigger the device to establish and automate operations to apply file segmentation restrictions and message recipients to be associated with or receive segmented portions of the file. Such embodiments enable savings in time, expertise, data usage, network usage, processing capacity and cycles, and memory. Further, such embodiments present user interface interactions which increase efficiency in interactions, consolidate device interactions, and otherwise change and improve user/device interaction and device capabilities. These embodiments may also improve security and distribution capabilities by ensuring recipients receive files with only relevant segments enabled and accessible. Multiple segments may be combined into a single file and distributed, or distributed across multiple files. The recipient may interact with segments of a file without having access to sections of the file not intended to be shared with the recipient. In some instances, the segments of the file may be sequentially presented.

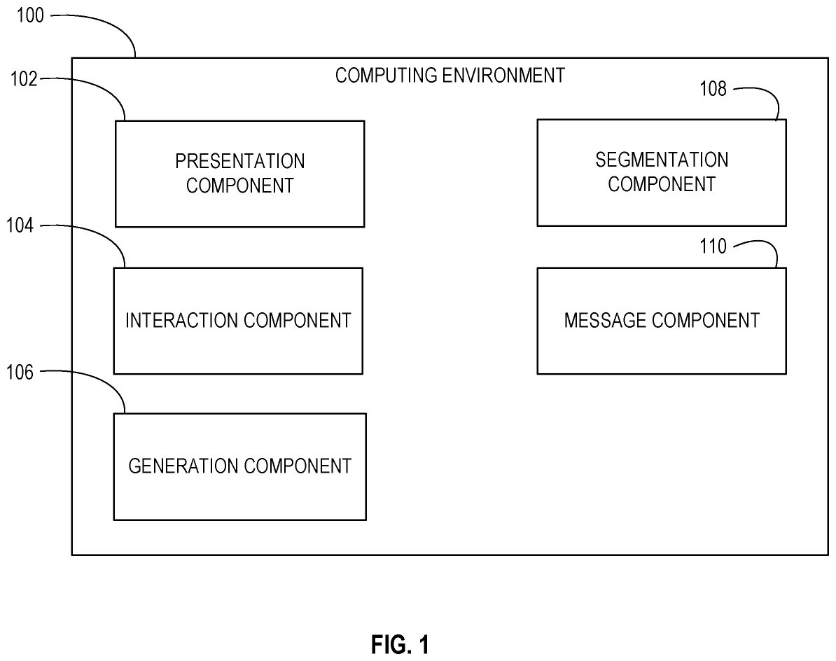

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may comprise a presentation component 102, an interaction component 104, a generation component 106, a segmentation component 108, and a message component 110. The presentation component 102 may generate and cause display of media, user interface elements, and other audiovisual elements described herein. The interaction component 104 may identify, track, and associate user interface interactions, voice instructions, or other input methods. The generation component 106 may generate user interface elements, user interface screens, and other programmatic components, elements, or operations described herein. The segmentation component 108 may generate file segments from one or more multimedia files or other suitable data. The segmentation component 108 may generate additional files by combining one or more file segments into a single file for distribution. The message component 110 may generate messages, attach file segments and distribution files to or within the messages, assign recipient contact information, and transmit messages over a computer network. In some embodiments, the message component 110 transmits messages to a plurality of different browsers, applications, or programs and determines formats to be associated with generated messages based on a browser, application, or program associated with or implementing one or more of the components of the components 102, 104, 106, 108, and 110 of the computing environment 100 described herein.

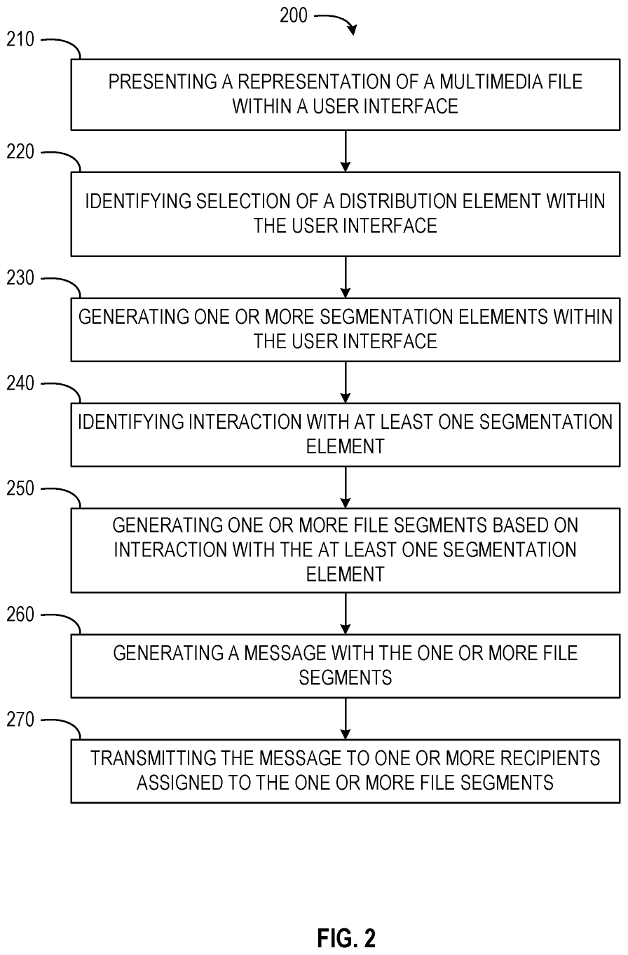

Referring now to FIG. 2, a flowchart of an example of a computer-implemented method 200 is shown. The computer-implemented method 200 is a method for segmenting and distributing portions of a file. In some embodiments, the computer-implemented method 200 may be performed by one or more components of the computing environment 100, as described herein.

At operation 210, the presentation component 102 causes presentation of a multimedia file within a user interface. In some instances, the presentation component 102 generates and presents a representation of a multimedia file within the user interface. The multimedia file, or representation thereof, may be a video file, an audio file, a document, a presentation, a slide show, a spread sheet, or any other suitable file. The presentation component 102 may present the multimedia file in a browser, an application, or any other suitable user interface-based program. The user interface containing the multimedia file may be presented on a display device of a computing device, such as a laptop, a desktop computer, a tablet, a smartphone, a mobile computing device, or any other suitable computing system.

In some instances, presentation of the multimedia file may be triggered by a user. For example, a user may open a browser or application. The user may direct the browser to a specified multimedia file and select a link or icon configured to open and display the multimedia file.

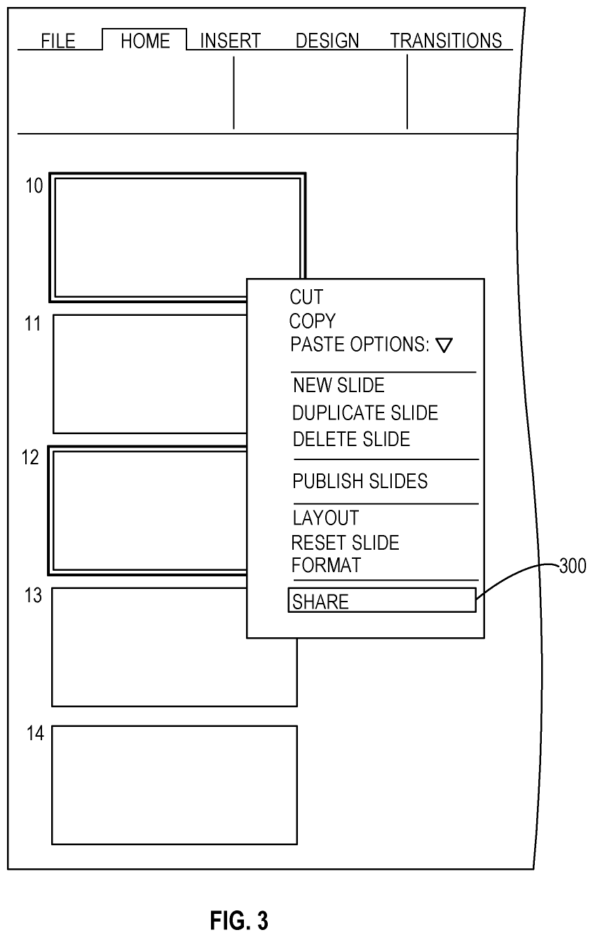

At operation 220, the interaction component 104 identifies selection of a distribution element within the user interface. The distribution element may be generated and presented within the user interface based on an interaction with the representation of the multimedia file. As shown in FIG. 3, a distribution element 300 is an interactive user interface element (e.g., an icon) configured to initiate segmentation and distribution of a file or multimedia file. For example, the distribution element 300 may be associated with a plug-in, an add-on, or an extension of a browser or application. The distribution element 300 may also be incorporated within an application or browser as a native portion of a program. As shown in FIG. 3, the distribution element 300 may be a “share” option or icon positioned within a menu or sub-menu displayed within the user interface of the browser or application. The distribution element may be shown in response to a right click, or other menu selection, relating to a specified portion of the file. As shown in FIG. 3, the distribution element 300 is presented as part of a menu after selection of one or more of the preview slides 10-14. Selection of the distribution element 300 may initiate automated or semi-automated detection and segmentation of the multimedia file.

In some embodiments, the distribution element 300 is a single distribution element, such as a share button. The distribution element 300 may also be a plurality of user interface elements. For example, the distribution element 300 may be a plurality of user interface elements, where each user interface element corresponds to a distribution type.

The distribution element 300 may also be a plurality of cascading user interface elements. The cascading user interface elements may be arranged in a hierarchy or other relational configuration, such that selection of an initial distribution element may cause presentation of one or more subsequent, related distribution elements. For example, an initial distribution element may be presented within a user interface as a share button within a set of menu options. Selection of the initial distribution element may cause presentation of one or more distribution elements associated with different types of distribution. The distribution types may be associated with differing mechanisms, manners, or systems of distributing data. For example, distribution types may include SMS messages, emails, text messages, links, posts in social media, posts within an internet forum or website, or any other suitable data distribution mechanisms or means. The interaction component 204 may identify a distribution type based on selection of a distribution element.

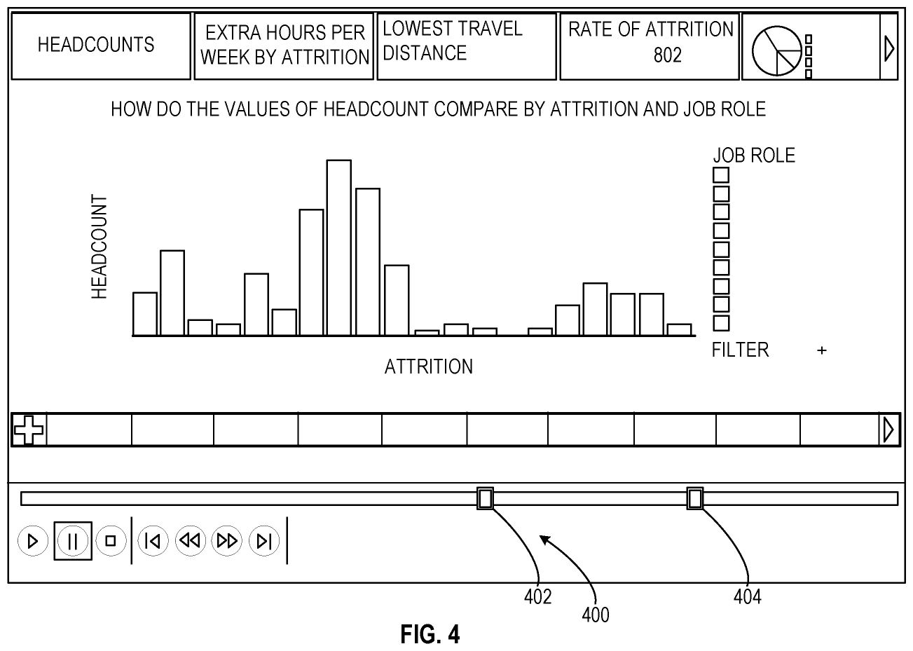

At operation 230, the generation component 106 generates one or more segmentation elements within the user interface. As shown in FIG. 4, one or more segmentation elements 400 (e.g., a first segment element 402 and a second segment element 404) may be generated based on a program, browser, or application in which selection of the distribution element occurred. For example, where the multimedia file is a video file displayed within a video player application or a portion of a browser, the one or more segmentation elements 400 may be generated as buttons, sliders, or other icons along a progress bar.

During display of the video, the progress bar may indicate a current time of the video being played. The one or more segmentation elements 400 may be generated along the progress bar and be moveable along the progress bar. For example, a first segmentation element may be generated with an initial position at a first point on the progress bar (e.g., a beginning of the multimedia file on a left-hand side of the progress bar). A second segmentation element may be generated with an initial position at a second point on the progress bar. The second point on the progress bar may be determined and positioned based on one or more of the total duration of the video file (e.g., positioned at the end of the progress bar), at a predetermined position (e.g., one quarter mark of the video or a last play position of the video), at a bookmarked position, or any other suitable position. In some embodiments, an initial segmentation element may be generated and presented within the user interface. Additional or subsequent segmentation elements may be generated and presented based on user interaction with the initial segmentation element or interaction with a predetermined portion of the user interface (e.g., the progress bar) in a similar manner used for the initial segmentation element.

In some embodiments, the one or more segmentation elements may be generated in response to user interaction with the user interface. In these instances, once the distribution element is selected, a next selection within a predetermined area of the user interface may trigger generation and presentation of a segmentation element. For example, in the instance of a video file, once the distribution element is selected, a click, tap, or other interaction with the progress bar may trigger generation and presentation of a first segmentation element. Subsequent interactions with the progress bar may generate additional segmentation elements. However, interaction with other portions of the user interface (e.g., portions of the user interface outside of the progress bar) may not trigger generation and presentation of a segmentation element. By way of further example, where the multimedia file is a presentation or slideshow, with a set of preview slides positioned along one side of the user interface, selection of the distribution element may cause subsequent selection or interaction with slides in the set of preview slides to trigger generation and position of the one or more segmentation elements within the set of preview slides. Although described with respect to specified user interfaces and specified file types, it should be understood that differing file types and differing applications or browsers may be similarly modified or triggered to generate segmentation elements based on one or more of selection of the distribution element and interaction with a specified portion of the user interface.

At operation 240, the interaction component 104 identifies interaction with at least one segmentation element of the one or more segmentation elements. In embodiments where the one or more segmentation elements (e.g., initial segmentation elements) are generated and presented within a user interface, the interaction component 104 identifies interaction with one or more of the segmentation elements generated and presented in operation 230. In embodiments where segmentation elements are generated based on interactions of the user following selection of the distribution element, the interaction component 104 may identify interaction with the at least one segmentation element responsive to user clicks, taps, or other interactions with a predetermined portion of the user interface (e.g., a progress bar, preview bar, etc.).

In some embodiments, interaction with the at least one segmentation element may be a single interaction. In such instances, the interaction component 104 may determine a first position of the multimedia file. The first position may correspond to a predetermined position within the multimedia file. The predetermined position may be a beginning or starting position, an ending position, or any position between a beginning and end of the multimedia file.

The interaction component 104 may determine a second position. The second position may be determined within the multimedia file and correspond to the interaction with the segmentation element. The second position may be a point or position within the multimedia file selected or otherwise indicated by an interaction with the user interface. For example, the second position may be selected by a user via a mouse click within the user interface, such as a mouse click along a progress bar to indicate selection of a time within a video. In some embodiments, the first position is determined based, in part, on the second position. For example, the first position may be determined as a start point or an end point of the multimedia file based on proximity of the second position to the start or end of the multimedia file.

In some embodiments, the interaction with the at least one segmentation element may be a plurality of interactions. In such instances, the interaction component 104 may determine a first position within the multimedia file. The first position may correspond to a first interaction with a segmentation element of the one or more segmentation elements.

The interaction component 104 may determine a subsequent position within the multimedia file after determining the first position. The subsequent position may correspond to a subsequent interaction with a segmentation element of the one or more segmentation elements.

At operation 250, the segmentation component 108 generates one or more file segments based on interaction with the at least one segment element. In some embodiments, the one or more file segments are generated from the multimedia file. The one or more file segments may be a part, portion, or subset of the multimedia file, or data contained therein. The segmentation component 108 may generate the one or more file segments by determining portions of the multimedia file positioned between two segmentation elements. In some embodiments, the segmentation component may generate the one or more file segments by determining portions of the multimedia file positioned between a segmentation element and a predetermined point in the multimedia file (e.g., a start point or an end point). Once the segmentation component 108 determines the portions of the multimedia file to be segmented, the segmentation component 108 may discard or mark for exclusion portions of the multimedia file outside of the identified portions (e.g., outside two or more segmentation elements).

In some embodiments, the one or more file segments may be generated based on, at least in part, an identified distribution type. For example, based on a specified distribution type, a plurality of file segments may be combined into a distribution file. The distribution file may exclude at least a portion of the multimedia file. The distribution file may contain one or more file segments. In some embodiments, a plurality of file segments flow into one another without interruption (e.g., individual segments spliced together to form a single video). In some instances, the plurality of file segments may be used to generate the distribution file with divisions between each segment. For example, menu screens, blank or black video portions, or other suitable dividing elements may be added or inserted between two or more segments within the distribution file.

At operation 260, the message component 110 generates a message with the one or more file segments. In some instances, the message is generated by attaching the one or more file segments to a blank message, such as an email, a text or SMS message, or a social media post. The message component 110 may also generate the message by attaching or incorporating the one or more file segments and generating message text to be transmitted along with the one or more file segments. In some embodiments, the message is generated with a distribution file, described above, and one or more recipients assigned to the distribution file. The message component 110 may generate the message, including the one or more file segments or the distribution file, without recipients. In these instances, once the message is generated, the message component 110 may identify and present a set of contacts or potential recipients to be included within the message, based on subsequent user selection. As described in more detail below, recipients may be identified and selected prior to generation of the message. In these instances, the message component 110 generates the message by populating one or more messages with pre-selected recipients. The message component 110 may then attach or insert the one or more file segments or distribution file into a blank or pre-filled message. Recipients may be identified by individual or name, a unique recipient identifier, a unique group identifier, a set of individuals or groups, a set of rules, or any other mechanism for identifying recipients.

At operation 270, the message component 110 transmits or distributes the message to one or more recipients assigned to the message or the one or more file segments. The message component 110 may transmit or distribute the message using one or more communication protocols. For example, the message component 110 may transmit or distribute the message, generated in operation 260, via text message, SMS message, email, social media post, or other suitable protocols, programs, or applications. In some embodiments, the message component 110 transmits or distributes the message via a plurality of message protocols, programs, or applications. For example, once generated, the message component 110 may transmit or distribute the message to two or more recipients, each recipient receiving the message via a different message protocol, program, or application.

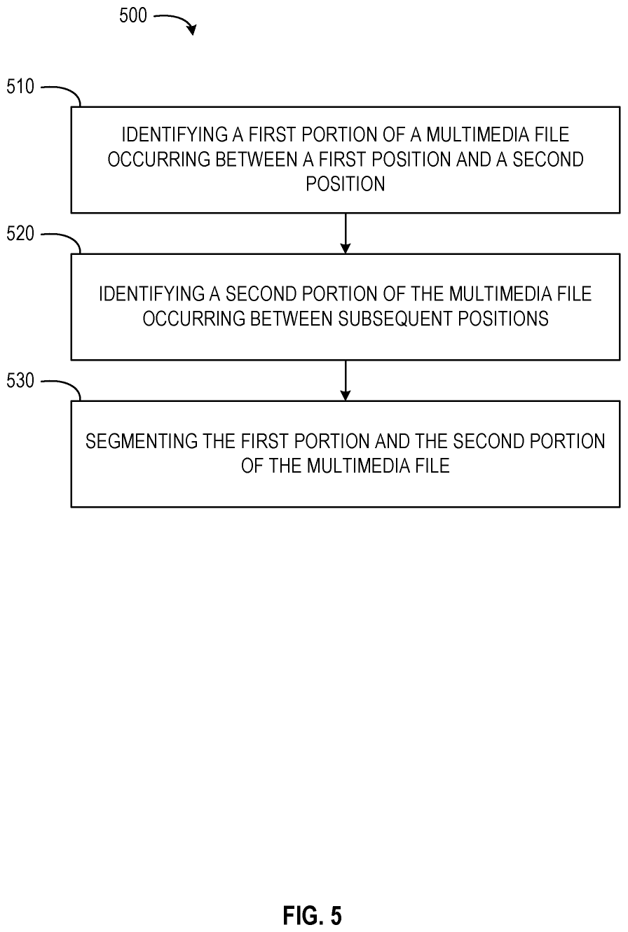

FIG. 5 shows a flowchart of an embodiment of a computer-implemented method 500 for segmenting and distributing portions of a file. The method 500 may be performed by or within the computing environment 100. In some embodiments, the method 500 comprises or incorporates one or more operations of the method 200. In some instances, operations of the method 500 may be incorporated as part of or sub-operations of the method 200.

In operation 510, the segmentation component 108 identifies a first portion of the multimedia file occurring between a first position and a second position. In some embodiments, the operation 510 is performed during or as a sub-operation of operation 250, described above. The segmentation component 108 may identify the first portion of the multimedia file by determining the first position, associated with a first segmentation element, and the second position, associated with a second segmentation element. The first and second segmentation elements may be identified chronologically, based on user pairing, based on automatically detected pairing of segmentation elements, or any other suitable relationship indicating the first and second segmentation elements delineate a desired portion of the multimedia file. The segmentation component 108 may identify the first portion based on a file type of the multimedia file. For example, in audio or video files, the segmentation component 108 may identify the first portion based on time codes within the multimedia file. The time codes may correspond to the positions associated with selected first and second segmentation elements.

In operation 520, the segmentation component 108 identifies a second portion of the multimedia file occurring between subsequent positions. The segmentation component 108 may identify the second portion of the multimedia file in a manner similar to or the same as described above with respect to operation 510, with differing positions associated with at least one subsequent segmentation element. In some embodiments, the segmentation component identifies the second portion based on positions of selected segmentation elements, exclusive of the segmentation element positions used to identify the first portion of the multimedia file. In some instances, the second portion of the multimedia file and the first portion of the multimedia file may share a position or have overlapping positions associated with selected segmentation elements.

In operation 530, the segmentation component 108 segments the first portion and the second portion of the multimedia file. The segmentation of the first portion and the second portion may remove or discard portions of the multimedia file not located in the first portion and the second portion. In some embodiments, the segmentation component 108 discards portions of the multimedia file by cropping or otherwise modifying the multimedia file. In some instances, the segmentation component 108 creates one or more additional files for file segments generated from the first portion and the second portion of the multimedia file. In these instances, the original multimedia file may remain without modification, while the file segments are generated as new files.

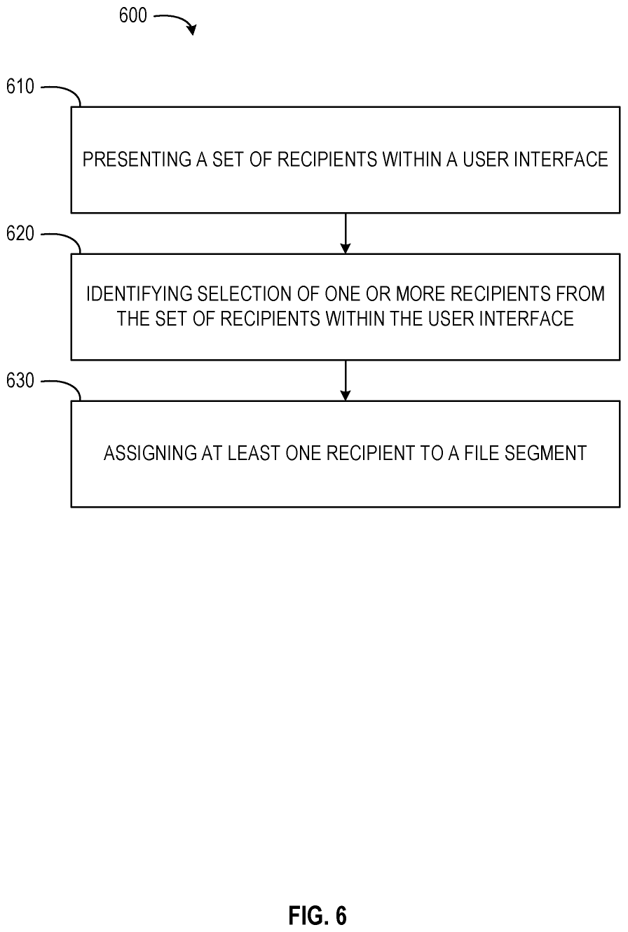

FIG. 6 shows a flowchart of an embodiment of a computer-implemented method 600 for segmenting and distributing portions of a file. The method 600 may be performed by or within the computing environment 100. In some embodiments, the method 600 comprises or incorporates one or more operations of the methods 200 or 500. In some instances, operations of the method 600 may be incorporated as part of or sub-operations of the methods 200 or 500.

In operation 610, the presentation component 102 causes presentation of a set of recipients. The set of recipients may be populated from a set of contacts within a user's device, email account, or any other suitable list to which the presentation component 102 is provided access. The contacts or users included in the set of recipients may be based on one or more of a device, an account, an application, a browser, privacy permissions, or any other suitable accessibility constraints. For example, the presentation component 102 may present the set of recipients from work related contacts where the user or sender is accessing the computing environment 100 on a work-related device or account. Similarly, where a personal computing device (e.g., a personal smartphone) is being used to execute the operations of the method 600, the presentation component 102 may access personal contacts in an address book of the personal computing device to populate the set of recipients.

In some embodiments, presentation of the set of recipients is performed based on or in response to selection of a distribution element. In such instances, upon identifying selection of a distribution element, the presentation component 102 may access an address book or contact list and cause presentation of one or more user interface elements (e.g., a menu, a list, or a text entry box) configured to receive and/or display the set of recipients. The set of recipients may be prepopulated and presented in a manner configured to allow a user to select from a prepared list of potential recipients. The set of recipients may also be presented a text entry field or box, selection of which causes presentation of at least a portion of the set of recipients. Similarly, entering text into the text entry field or box may cause presentation of the set of recipients using autocomplete functionality, selectively accessing and presenting the set of potential recipients based on user input. Wildcards, group memberships, or associations with other elements or according to various rules or criteria may be utilized to select a set of recipients.

In some embodiments, presentation of the set of recipients is performed based on or in response to generating one or more file segments. In these embodiments, the segmentation component 108 may generate the one or more file segments, as described above with respect to operation 250. The segmentation component 108 may trigger the presentation component 102 to present the set of recipients or potential recipients once the file segments have been generated.

In operation 620, the interaction component 104 identifies selection of one or more recipients within the user interface. Selection of the one or more recipients may be identified through user interface interactions, such as a tap, click, swipe, voice instruction, or other suitable user input. In some embodiments, the interaction component 104 identifies selection of the one or more recipients until a terminating element is engaged. For example, the interaction component 104 may continue adding recipients to a list of recipients until the interaction component 104 identifies selection of an “OK,” “Next,” or “Done” user interface icon or element.

In operation 630, the segmentation component 108 assigns at least one recipient to a file segment. In some embodiments the segmentation component 108 assigns the at least one recipient to each file segment by inserting an identifier for the at least one recipient into metadata generated along with each file segment. In some instances, the segmentation component 108 passes the file segments and selected recipients to the message component 110. The selected recipients or the file segments may be annotated by the segmentation component 108 to indicate which recipient is to be associated with which file segment or file segments. In these instances, the message component 110 may assign recipients to file segments by inserting an appropriate recipient identifier or contact information into a message header and attaching an appropriate file segment or file segments to a message body.

In some embodiments, assigning the at least one recipient to the file segment is performed in response to or based on identifying an interaction with at least one segmentation element and generating one or more file segments. In such instances, interaction with the at least one segmentation element may initiate segmentation of the multimedia file between specified positions. The file segment or file segments resulting from the segmentation may be generated prior to presentation of the set of recipients and selection of the one or more recipients. For example, the segmentation component 108 may generate a segment, as discussed above. The presentation component 102 may present user interface elements representing the newly created segment. One or more of the user interface elements may correspond to recipients of the set of recipients. Selection of one or more recipient, by selection of a user interface element presented in conjunction with the newly generated file segment, may cause the segmentation component 108 to assign each recipient (e.g., each recipient associated with a selected user interface element) to the newly created file segment.

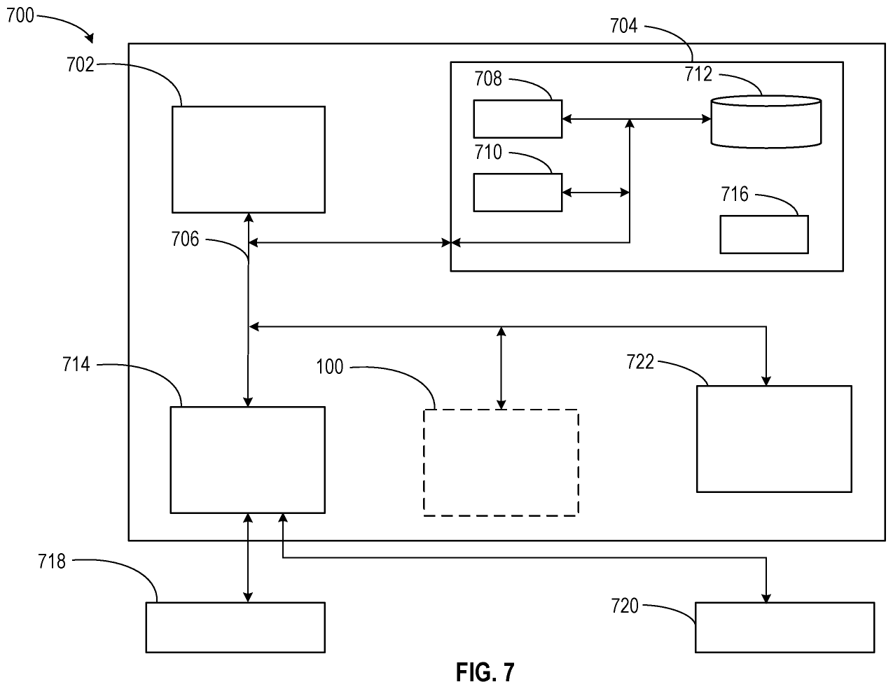

Embodiments of the present disclosure may be implemented together with virtually any type of computer, regardless of the platform, being suitable for storing and/or executing program code. FIG. 7 shows, as an example, a computing system 700 suitable for executing program code related to the methods disclosed herein.

The computing system 700 is only one example of a suitable computer system and is not intended to suggest any limitation as to the scope of use or functionality of embodiments of the present disclosure described herein, regardless, whether the computer system 700 is capable of being implemented and/or performing any of the functionality set forth hereinabove. In the computer system 700, there are components, which are operational with numerous other general purpose or special purpose computing system environments or configurations. Examples of well-known computing systems, environments, and/or configurations that may be suitable for use with computer system/server 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 700 may be described in the general context of computer system-executable instructions, such as program modules, being executed by a computer system 700. Generally, program modules may include routines, programs, objects, components, logic, data structures, and so on that perform particular tasks or implement particular abstract data types. Computer system/server 700 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 700 is shown in the form of a general-purpose computing device. The components of computer system/server 700 may include, but are not limited to, one or more processors 702 (e.g., processing units), a system memory 704 (e.g., a computer readable storage medium coupled to the one or more processors), and a bus 706 that couple various system components including system memory 704 to the processor 702. Bus 706 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 700 typically includes a variety of computer system readable media. Such media may be any available media that is accessible by computer system/server 700, and it includes both, volatile and non-volatile media, removable and non-removable media.

The system memory 704 may include computer system readable media in the form of volatile memory, such as random access memory (RAM) 708 and/or cache memory 710. Computer system/server 700 may further include other removable/non-removable, volatile/non-volatile computer system storage media. By way of example only, a storage system 712 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 706 by one or more data media interfaces. As will be further depicted and described below, the system memory 704 may include at least one program product having a set (e.g., at least one) of program modules that are configured to carry out the functions of embodiments of the present disclosure.

The program/utility, having a set (at least one) of program modules 716, may be stored in the system memory 704 by way of example, and not limiting, as well as an operating system, one or more application programs, other program modules, and program data. Program modules may include one or more of the presentation component 102, the interaction component 104, the generation component 106, the segmentation component 108, and the message component 110. Each of the operating systems, one or more application programs, other program modules, and program data or some combination thereof, may include an implementation of a networking environment. Program modules 716 generally carry out the functions and/or methodologies of embodiments of the present disclosure, as described herein.

The computer system/server 700 may also communicate with one or more external devices 718 such as a keyboard, a pointing device, a display 720, etc.; one or more devices that enable a user to interact with computer system/server 700; and/or any devices (e.g., network card, modem, etc.) that enable computer system/server 700 to communicate with one or more other computing devices. Such communication can occur via Input/Output (I/O) interfaces 714. Still yet, computer system/server 700 may communicate with one or more networks such as a local area network (LAN), a general wide area network (WAN), and/or a public network (e.g., the Internet) via network adapter 722. As depicted, network adapter 722 may communicate with the other components of computer system/server 700 via bus 706. It should be understood that, although not shown, other hardware and/or software components could be used in conjunction with computer system/server 700. Examples include, but are not limited to: microcode, device drivers, redundant processing units, external disk drive arrays, RAID systems, tape drives, and data archival storage systems, etc.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The computer readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

What is claimed is:

1. A method, comprising:
presenting a representation of a multimedia file within a user interface;
identifying selection of a distribution element within the user interface, the distribution element generated based on interaction with the representation of the multimedia file;
based on selection of the distribution element, generating one or more segmentation elements within the user interface;
identifying an interaction with at least one segmentation element of the one or more segmentation elements;
generating one or more file segments from the multimedia file based on the interaction with the at least one segmentation element; and
generating a message with the one or more file segments.

2. The method of claim 1, wherein the interaction with the at least one segmentation element is a single interaction, the method further comprising:
determining a first position corresponding to a predetermined position within the multimedia file; and
determining a second position within the multimedia file corresponding to a position of the interaction with the segmentation element.

3. The method of claim 1, wherein the interaction with the at least one segmentation element is a plurality of interactions, the method further comprising:
determining a first position within the multimedia file corresponding to a first interaction with a segmentation element of the one or more segmentation elements; and
determining a subsequent position, within the multimedia file, corresponding to a subsequent interaction with a segmentation element of the one or more segmentation elements.

4. The method of claim 1, wherein generating the one or more file segments further comprises:
identifying a first portion of the multimedia file occurring between a first position and a second position within the multimedia file;
identifying a second portion of the multimedia file occurring between subsequent positions within the multimedia file; and
segmenting the first portion and the second portion of the multimedia file.

5. The method of claim 1, further comprising:
based on the selection of the distribution element, presenting a set of recipients;
identifying selection of one or more recipients within the user interface; and
in response to identifying the interaction with at least one segmentation element and generating the one or more file segments, assigning at least one recipient to each file segment.

6. The method of claim 1, further comprising:
based on generating the one or more file segments, presenting a set of recipients;
identifying selection of one or more recipients within the user interface; and
assigning at least one recipient to each file segment.

7. The method of claim 1, wherein the one or more file segments is a plurality of file segments, the method further comprising:
based on the selection of the distribution element, identifying a distribution type;
based on the identified distribution type, combining the plurality of file segments into a distribution file excluding at least a portion of the multimedia file; and
generating the message with the distribution file and one or more recipients assigned to the distribution file.

8. A system, comprising:
one or more processors; and
a computer readable storage medium coupled to the one or more processors, the computer readable storage medium storing program instructions that, when executed by the one or more processors, cause the one or more processors to perform operations comprising:
presenting a representation of a multimedia file within a user interface;
identifying selection of a distribution element within the user interface, the distribution element generated based on interaction with the representation of the multimedia file;
based on selection of the distribution element, generating one or more segmentation elements within the user interface;
identifying an interaction with at least one segmentation element of the one or more segmentation elements;
generating one or more file segments, from the multimedia file, based on the interaction with the at least one segmentation element; and
generating a message with the one or more file segments.

9. The system of claim 8, the interaction with the at least one segmentation element is a single interaction, the operations further comprising:
determining a first position corresponding to a predetermined position within the multimedia file; and
determining a second position, within the multimedia file, corresponding to a position of the interaction with the segmentation element.

10. The system of claim 8, wherein the interaction with the at least one segmentation element is a plurality of interactions, the operations further comprising:
determining a first position, within the multimedia file, corresponding to a first interaction with a segmentation element of the one or more segmentation elements; and
determining a subsequent position, within the multimedia file, corresponding to a subsequent interaction with a segmentation element of the one or more segmentation elements.

11. The system of claim 8, wherein generating the one or more file segments further comprising:
identifying a first portion of the multimedia file occurring between a first position and a second position within the multimedia file;
identifying a second portion of the multimedia file occurring between subsequent positions within the multimedia file; and
segmenting the first portion and the second portion of the multimedia file.

12. The system of claim 8, wherein the operations further comprise:
based on the selection of the distribution element, presenting a set of recipients;
identifying selection of one or more recipients within the user interface; and
in response to identifying the interaction with at least one segmentation element and generating the one or more file segments, assigning at least one recipient to each file segment.

13. The system of claim 8, wherein the one or more file segments is a plurality of file segments, the operations further comprising:
based on the selection of the distribution element, identifying a distribution type;
based on the identified distribution type, combining the plurality of file segments into a distribution file excluding at least a portion of the multimedia file; and
generating the message with the distribution file and one or more recipients assigned to the distribution file.

14. A computer program product comprising a computer readable storage medium having program instructions embodied therewith, the program instructions being executable by one or more processors to cause the one or more processors to perform operations comprising:
presenting a representation of a multimedia file within a user interface;
identifying selection of a distribution element within the user interface, the distribution element generated based on interaction with the representation of the multimedia file;
based on selection of the distribution element, generating one or more segmentation elements within the user interface;
identifying an interaction with at least one segmentation element of the one or more segmentation elements;
generating one or more file segments, from the multimedia file, based on the interaction with the at least one segmentation element; and
generating a message with the one or more file segments.

15. The computer program product of claim 14, wherein the interaction with the at least one segmentation element is a single interaction, the operations further comprising:
determining a first position corresponding to a predetermined position within the multimedia file; and
determining a second position, within the multimedia file, corresponding to a position of the interaction with the segmentation element.

16. The computer program product of claim 14, wherein the interaction with the at least one segmentation element is a plurality of interactions, the operations further comprising:
determining a first position, within the multimedia file, corresponding to a first interaction with a segmentation element of the one or more segmentation elements; and
determining a subsequent position, within the multimedia file, corresponding to a subsequent interaction with a segmentation element of the one or more segmentation elements.

17. The computer program product of claim 14, generating the one or more file segments further comprises:
identifying a first portion of the multimedia file occurring between a first position and a second position within the multimedia file;
identifying a second portion of the multimedia file occurring between subsequent positions within the multimedia file; and
segmenting the first portion and the second portion of the multimedia file.

18. The computer program product of claim 14, wherein the operations further comprise:
based on the selection of the distribution element, presenting a set of recipients;
identifying selection of one or more recipients within the user interface; and
in response to identifying the interaction with at least one segmentation element and generating the one or more file segments, assigning at least one recipient to each file segment.

19. The computer program product of claim 14, wherein the operations further comprise:
based on generating the one or more file segments, presenting a set of recipients;
identifying selection of one or more recipients within the user interface; and
assigning at least one recipient to each file segment.

20. The computer program product of claim 14, wherein the one or more file segments is a plurality of file segments, the operations further comprising:
based on the selection of the distribution element, identifying a distribution type;
based on the identified distribution type, combining the plurality of file segments into a distribution file excluding at least a portion of the multimedia file; and
generating the message with the distribution file and one or more recipients assigned to the distribution file.
